(19) United States
(12) Patent Application Publication
(10) Pub. No.: US 2020/0261825 A1
(43) Pub. Date: Aug. 20, 2020

(54) Method for Control of Packed Bed Extraction Systems

(71) Applicants: Marc Philip Privitera, Walnut Creek, CA (US); Christina Metz Borgese, Walnut Creek, CA (US)

(72) Inventors: Marc Philip Privitera, Walnut Creek, CA (US); Christina Metz Borgese, Walnut Creek, CA (US)

(21) Appl. No.: 16/279,919

(22) Filed: Feb. 19, 2019

(51) Int. Cl. B01D 15/16; B01D 15/18; B01D 53/02

(52) U.S. Cl. CPC B01D 15/163; B01D 53/025; B01D 15/18

(57) ABSTRACT

A method of controlling the liquid or gas flow disturbance impulses in a system for the extraction of targeted constituents from a liquid or gas through the coordination of the acceleration of the valves and pumps in such a way that the fluid pulsations and impact dynamics that cause the destruction of the internal is minimized through a reduction of hydrodynamic pulses propagated through the system.

### PRIORITY DATE CLAIM

Provisional Patent Application 62/635,411 is incorporated in this application in its entirety. The priority date of the provisional application is claimed.

### PRIOR ART

Prior art includes many applications of materials and systems for extracting and isolating targeted constituents can be found in prior art. Examples include U.S. Pat. Nos. 8,753,594B1, 6,280,693, 8,637,428B1, 5,599,516A, U.S. Ser. No. 08/716,954, U.S. Pat. Nos. 8,309,043B2, 5,993,759A.

The invention disclosed in this application improves upon prior art by presenting unique solutions to the hydrodynamic degradation of the materials used in extraction systems and enables the improved effectiveness of the systems described prior disclosed systems and methods. It discloses the advantages over prior art by combining the use of various individual chemical process control functions into a system which presents a unique application for the control of systems for the extraction of targeted constituents from liquids and gasses.

### BACKGROUND OF THE INVENTION

A common chemical process unit operation is the use of a material, usually in the form of a flowable solid particle, which has an affinity fora certain targeted constituent when presented to the liquid or gas containing that constituent in combination with the right process conditions. These are commonly arranged in packed bed columns. Common examples of the application is for sorbent separation processes found in many chemical industries, ion exchange resin purification systems found in water treatment systems and catalytic reaction systems found in the oil and gas processing industry.

This invention reduces the degradation of the material internal to the column by presenting a method of control to reduce the hydrodynamic shock on the particles which encourages the grinding and degradation of the particles. The degradation of the material of the internals of a packed bed column reduces the interstitial space available for fluid flow. The reduction of the interstitial space increases the pressure drop of the column reducing the flow capacity. Ultimately the maximum pressure of the column is reached and it them must be taken off line for replacement of the internal material. The cost of the system is dependent upon not only the capacity of the column, but also the time cycle required between each empty and refill of the column due to the degradation of the internal material.

A conventional packed bed extraction column is commonly a large diameter (on the order of 8 to 12 feet) column with an aspect ratio of usually 1 or 1.5 to 1 when comparing the diameter to the height. These columns can be sized using the superficial velocity of the fluid passing through the column. Commonly a lower superficial velocity is desired. The lower superficial velocity allows an equilibrium to form between the fluid constituents and the functional material that retains or operates on the desired targeted constituent. The functional material fills the large diameter column. Larger diameter columns suffer from the possibility of mal-distribution. This disturbs the desired chromatographic front that can develop the highest possible mass transfer driving force in the system. A chromatographic front is where the concentration of the targeted constituent is sharply uniform across the surface area of the moving fluid mass as it moves as a unit along the flow pathway of the column. Mal-distribution is where the concentration gradient of the fluid passing through the column is broken into varying concentration profiles across the surface area of the “front” along the flow pathway. The larger the diameter, the greater the possibility of mal-distribution

The extraction capacity of the system is defined as the mass of targeted constituent that can be retained by the internal material of the packed bed column. A common value might be, but is not limited to, 2 grams of targeted constituent per liter of internal material. In these systems the physical operation is controlled by comparing the inlet concentration of the targeted constituent with the outlet concentration of the targeted constituent.

The flow capacity of the system is dependent upon the interstitial space available in the material that fills the column.

There are different types of flows into the system. As described above the columns may be in one of the three daisy chain modes: lead, lag, or regeneration. There are also different types of fluid flow depending upon the specific sequence to best extract the targeted constituents. Each of these sequences are unique and novel, but are commonly held as trade secrets as opposed to being disclosed in patent art.

During load flow the stream containing the source of the targeted constituent is directed through first the lead column followed by the lag column.

There are different measurement terms to control the columns.

Bleed is the concentration of the outlet stream that is unable to be captured by the internal material. A typical value might be 20 mg/kg concentration of the targeted constituent. This is the baseline level of bleed which is a characteristic of the column fill material.

Breakthrough is the point at which the concentration of the of the targeted constituent first rises above the bleed level in the outlet flow. This is commonly the point at which the column that is in the lead position is switched to the lag position.

Saturation is when the outlet stream concentration matches the inlet stream concentration of the targeted constituent. This occurs once the internal material has reached a point that all available extraction sites have been filled by the targeted constituent.

A common problem with large diameter columns is that not all available sites are able to be presented with the most advantageous mass transfer conditions due to the possibility of a variable chromatographic front due to mal-distribution.

At saturation, the column in lag is switched to regeneration. A second stream, different from the load flow stream is passed through the column to displace the residual liquid from the load flow. This lowers the concentration of impurities and the non-targeted constituents. A third flow, commonly called the strip, comprised of an appropriate constituent concentration make up removes, or strips, the targeted constituent from the internal material of the column. This flow is known as product flow when the concentration of the strip flow is rich in the targeted constituent.

A typical packed bed column used in the manner described briefly above has a series of valves that controls the flow path of feed streams to and discharge streams from the functional columns. Each time a fluid pathway is switched due to the sequence required to operate the columns, flow disturbances can be transmitted through the system. These flow disturbances usually create turbulent flow areas in the system disturbing the sharp concentration profile in the various parts of the system. As described, any back mixing, or turbulent disturbance that degrades the sharp concentration profile interfaces reduces the performance of the column by lowering the mass transfer driving force between the internal materials in the system and the fluids passing through the functional volume of the column. This invention is a chemical process automated control method that coordinates the opening of a valve, the speed of a pump, and the closing of a second valve that occurs during a fluid routing switch during operation of a packed bed extraction system.

The elements: the pumps, the opening valve of the new flow path, and the closing valve of the previous flow path, are present in all the various streams that feed and discharge from the column system.

A critical parameter for any packed bed column system is the particle size and the particle size distribution of the material that fills the columns used for constituent extraction. Smaller particles give higher the surface area in the system, however, smaller particles, with a wide particle size distribution, are more tightly packed thus reducing the interstitial space between particles. With less interstitial space, the pressure drop of the fluid flow through the bed is higher. Commonly, a practical limit of 100 psig to 125 psig exists in the design parameters of any column. In packing of particles into a bed, there is a defined balance between the interstitial space and the available surface area of each particle that that determines the performance of the system. The larger the particles, or the more uniform the particle size distribution, then the greater the interstitial space. If the particle size distribution is tightly controlled so that the different sized particles are limited to a narrow region of possible diameters, then the interstitial space is greater. If the particle size distribution is a wider range of sizes, the smaller diameter particles fill in the interstitial spaces between the larger particles thus effectively reducing the overall interstitial space. In the operation of packed bed columns, changes in the interstitial space is indicated by a change in the pressure drop across the column. As the column ages, the particles degrade, and the particle size distribution becomes wider such that the degrading particles fill the previously open interstitial space. Conventionally the hydrodynamics of the flow generates shearing forces between particles which degrade the particles. This shearing action during operation of the system broadens the particle size distribution and increases the pressure drop through the column. As the pressure drop increases to the operational limits, the column must be taken out of service and either backwashed to remove a portion of the fines, or smaller particles, or the internal material must be removed and replaced by new material to bring the column back within operational pressure drop parameters. Most of the particle degradation is caused by impact pulsations dur to hydrodynamic disturbances that are propagated through the material in the column driving the mechanical grinding action of the particles throughout the column.

### DESCRIPTION OF THE INVENTION

A method of process control for a system for the extraction of targeted constituents from a liquid or gas.

Through the coordination of the control of valve opening, closing and pump speeds, the hydrodynamic flow is tempered in such a way that the pulsations that initiate the grinding of the internal material due to particle to particle shear is minimized through the reduction of the hydrodynamic pulses.

The method uses an algorithm written in a programmable device with appropriate input and output signals. The method coordinates the control of the speed and acceleration of the motor that is driving the pump that creates the pressure on the liquid for flow through the valves, piping and column with the valve accelerations themselves. This invention controls the acceleration of the actuation of the valve which changes the diameter of the flow path opening in the valve. Combining these two control elements into an algorithm which reduces the velocity of the fluid at the precise timing of these flow transitions is critical to reducing the hydrodynamic disturbances through the system.

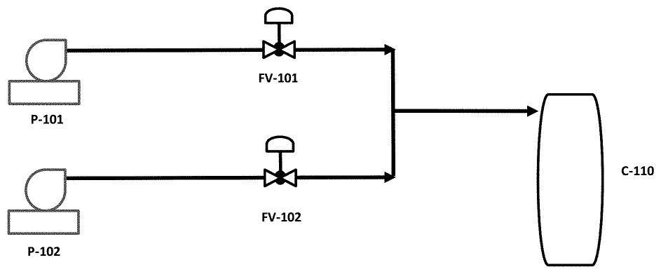

A typical equipment arrangement could be similar to the arrangement shown in FIG. 1.

### BRIEF DESCRIPTION OF FIG. 1

FIG. 1 shows and arrangement of a column, C-110, and two pumps and valves, P-101 associated with FV-101 and P-102 associated with FV-102, that would be typically employed in this invention. The fluid flows from each of the pumps through the associated valve and into the column as described in the method of the invention.

In the conventional system, the large diameter columns have self-damping characteristics in this flow behavior, in smaller diameter columns, the control of the change in velocity of the liquid stream around the particles contained in the column becomes more of a concern.

In addition to the benefits described above, this invention solves problems with the mechanical dynamics that are present in the conventional approach. In a conventional approach, the internals are subjected to great dynamic movement, vibration and surface to surface interaction. These dynamics grind the internals such that particles or structures become smaller and smaller. As the packed bed of internal vibrates, the ground smaller pieces fill the previously open interstitial spaces and the pressure drop increases.

In many embodiments, the internals of the column must be constructed of size exclusion material. A size exclusion material is commonly one that allows certain sized materials to pass into its structure while not allowing other sized materials to pass into its structure. Thus, the material physically excludes certain sized materials and constituents. These can be one of many types of alumnosilicates that has a high surface area and that has been activated by one of many methods using various chemicals. An example might be where the activation of the material is completed with a hydroxide and acid reaction sequence to develop the sites for constituent capture. After the sites are established, the material is then chemically reacted to build a structurally stable particle to enable its use in make up the internals of the packed bed. These activated materials and the use of these materials in this type of system is much more susceptible to damage due to hydraulic dynamics as opposed to conventional ion exchange resin which usually has a more robust structure. This invention solves the problem associated with the brittle and friable nature of the alumnosilicates. This invention also solves the similar problem that is also found in ion exchange resin and reactive catalyst applications. All three of these types of materials, along with many other examples of other materials being used in chemical operations, benefit from the method of control described in this invention.

The degradation of material creates an increased pressure drop in the system. An increased pressure drop reduces the flow that can be obtained through the system, thus reducing the capacity of the system. The reduced capacity and higher pressure drop leads to more dynamic action as more flow is attempted to processed through the column thus exacerbating the grinding, and exponentially increasing the reduction of the interstitial space. At some point the column is rendered inoperable due to the pressure exceeding the maximum allowable pressure drop of the system. This invention reduces this dynamic destruction of the internals by reducing the stress on the internals and keeping the pressure drop low. The lower pressure drop reduces the grinding and allows increased capacity and longer replacement time cycles of the materials of the system. This in turn increases internal useful life and allows for lower cost operation.

The switching of the columns between different operational modes as described is dependent upon conditions in the column initiating the switch. The term in industry used for these different liquid or gasses that are created by the switching of the valves controlling the flow can be referred to a “cut”. In conventional column separation systems, the cuts defining each composition through the column is controlled by switching the flow at a steady rate at defined time after duration of time running the liquid or gas through the column. These time at flow rate switching methods are determined by off line analysis of samples taken from the system at certain time intervals. These samples are physically collected from a sample port in the piping system. These are single point measurements with a practical limitation in the number that can be taken and the number that can be analyzed in a reasonable time. The response lag time, or the time between when the sample is taken and time when the result is available can be on the order of 2 to 4 hours. With flow rates for some of the industrial systems being on the order of 5000 gpm-10000 gpm, the control of the system is limited to accepting a large volume of material passing through the system prior to being able to affect changes in the operating parameters to enable a higher level of performance of the system. No consideration can given to the actual concentration of the intended targeted constituent at the time when the sample is taken to affect the immediate adjustment of the control system of the process when using this common off-line analysis method.

The more immediate that each operating condition can be determined in real time, an example for the simple examples during the “load” of the column of bleed, breakthrough and saturation, then the more effective is the operation of the system. Additionally, the more specific in real time each operating condition can be determined during the other common functional operating modes of the column which could include, but are not limited to strip, wash, backwash, and flush, then the more effective each operating mode of the column can be completed increasing capacity, improving quality and reducing cost.

This invention determines the specific concentration of the targeted constituent real time and in the flow stream of the process system to enable a specific concentration cut point to be determined. Conventionally, the time at flow cut points are determined experimentally by taking samples at the various intervals and waiting for the analytical off line turn around to verify that the proper cut point was anticipated in the operation of the system. This invention makes the cut point defined and dependent upon the real time concentration of the targeted constituent in the system through the application of a feedback loop algorithm developed to control the system based on the use of the on-line analytical measurement of the concentration of the targeted constituents.

In the collection of the different cuts when coordinated with the various storage requirements and overlapping coordination of the flows, each functional phase and thus resulting cut from the column may take a different duration of time. Since these systems have a continuous feed, it is important to always have available the column capacity in the correct mode to enable the continuous extraction of the liquid or gas containing the desired targeted constituent.

In conventional systems, columns are arranged in sets of three so that they can daisy chain between lead, lag and regeneration. Usually the duration of the column in each phase is described using number of bed volumes of flow. A bed volume is defined as the amount of liquid or gas that fills the column when combined with the material packed internally into the column.

A daisy chain arrangement, as it is known in the industry, is a series of three columns where one is in the lead position, one is in the lag position and one is in the regeneration position. Each column is rotated through each of the three functional positions depending upon the targeted constituent's specific concentration difference between the inlet flow to the column and the outlet flow from the column. The time that a column is in each of the functional positions can be different. For example, a column could be in the lead position for eight bed volumes of flow. The flow of a packed bed system is usually a steady rate, so the time the column is in the lead position is equivalent to the time it takes to flow 8 bed volumes of liquid through the system. The column can be moved to the lag position, and the column might be in the lag functional position of only four bed volumes. Ina conventional system, each column is fed from a collection of tanks holding different concentrations of various constituents depending upon the resulting materials flow history through the columns. This invention reduces the needed volume, reduces the dynamic shock on the internals components of the system, and makes use of post column concentration methods not available previously in conventional systems. The simplified column sequence in this invention uses an embodiment of the invention is described by the following sequence. These streams are run through different types of equipment, most commonly packed bed columns. Lithium specifically is selectively adsorbed onto the internal packing of the packed bed column. The internals made up primarily of treated material in the form described below is operated using a specific sequence set of steps. The sequence of flows is required to displace various residual streams minimizing impurities and maximizing concentration of the targeted constituent for isolation. The conventional system performance is limited by the ability to increase the concentration of the targeted constituent and decrease concentration of the undesired impurities. Conventionally, streams dilute in the targeted constituent must be recycled thus creating specific sequences and column arrangements that require large volume internal components and flow. Large volume internals which may include sorbent particles, sorbent fibers, separation membranes, plates, and other known separation materials must be arranged such that a sharp distinct difference in the concentration of the stream flowing through the equipment containing the internals is present to enable the mass transfer of the targeted constituent to the internals. These internals are the extracting materials.

An example of the conventional approach is described by the following sequence. A column of sufficient diameter to support the needed flowrate and of a height with a ratio of diameter to height of 1 to 3 filled with a particle that has been treated to capture and extract a specific constituent present in the flow is fed liquid or gas at an appropriate rate. The targeted constituent is held on sites on the extracting material, in this case, the particle. Saturation occurs once the extracting material has reached a point that all available extraction sites have been filled by the targeted constituent. A second stream is flowed through the column to displace the residual liquid from the initial flow. This lowers the impurities, or the non-targeted constituents. A third flow comprised of an appropriate constituent concentration removes the targeted constituent from the extracting material. This is known as product flow. The sequence duration and specific makeups of each of these streams determine the performance of the column. In many cases streams of dilute concentration of the targeted constituent are used in the sequence. This requires the equipment to be large volume, therefore affecting the stability of the sharp concentration profile needed to drive mass transfer. There are many other possible sequences including intermediate arrangements of the columns as well. There are also many other methods of extracting the targeted constituents including using the extraction material sites to grab the unwanted impurities. Other methods include steps not addressed here which could be wash, breakthrough, backwash, and regeneration.

1. A method of controlling the acceleration of at least one pump coupled with the acceleration of at least one valve such that the pressure wave that propagates through liquid or gas in a piping system is controlled to reduce the physical hydrodynamics effecting the flow characteristics through open pipes or packed beds comprising:
a. a predetermined dimension of piping having the flow path volume between the valves and pumps arranged in such a way that the volume in between the plurality of valves and pumps has the least possible acceleration transmitted to that volume caused by the acceleration of the pumps and valves; and,
b. a method of timing the actions of a plurality of pumps and valves with a possible arrangement of the equipment shown in FIG. 1, such that the action of the valves opening and closing acceleration occurs within a duration of time that allows the open area of the valves to total 130% or greater than the equivalent cross-sectional area of any single pipe in the flow path created by the opening and closing of the valves while the positive or negative acceleration of the plurality of pumps occurs.

2. An apparatus connected in the piping system that can measure the concentration of at least one targeted constituent while the fluid is flowing through the apparatus that enables the initiation of the acceleration of the plurality of valves and pumps in the system to switch the flows between the load, the strip, the wash, the backflush, the spent, the product, the wash, the lead, the lag, or the regeneration to flow through the system where the volume at the measurement location is large enough to reduce the flow dynamics through the measurement point to not disturb the measurement allowing a stagnant volume of material to remain in the measurement location for a duration of time long enough to have the material remain in the cell area for 150% of the cycle time of the measurement device and the number of samples required for a statistically determined result.

3. A method of using a sequence of steps that includes combining the conventional lag volume into one feed tank to allow the difference in the lead capacity and the lag capacity and the resulting overall time duration of those steps in the sequence of operations to be more in balance by decoupling each individual lead lag column in the conventional daisy chain arrangement.
